(19) United States
(12) Patent Application Publication
(10) Pub. No.: US 2021/0003976 A1
(43) Pub. Date: Jan. 7, 2021

(54) Method and device for operating an actuator regulation system, computer program and machine-readable storage medium

(71) Applicants: ROBERT BOSCH GMBH, Stuttgart (DE); TECHNISCHE UNIVERSITAT DARMSTADT, Darmstadt (DE)

(72) Inventors: Bastian BISCHOFF, Esslingen (DE); Julia VINOGRADSKA, Stuttgart (DE); Jan PETERS, Seeheim-Jugenheim (OT Malchen) (DE)

(21) Appl. No.: 16/756,953

(22) PCT Filed: Aug. 10, 2018
(86) PCT No.: PCT/EP2018/071753

§ 371 Date: Apr. 17, 2020

(30) Foreign Application Priority Data
Oct. 20, 2017 (DE) 10 2017 218 811.1

(51) Int. Cl. G05B 13/04; G06F 17/11

(52) U.S. Cl. CPC G05B 13/041; G06F 17/11

(57) ABSTRACT

A method for operating an actuator regulation system which is designated to regulate a regulation variable of an actuator to a pre-definable target variable, the actuator regulation system being designated to generate a correcting variable according to a variable characterizing a regulation strategy, and to control the actuator according to the correcting variable, the variable characterizing the regulation strategy being determined according to a value function.

The invention relates to a method for operating an actuator regulation system, a learning system, the actuator regulation system, a computer program for executing the method and a machine-readable storage medium on which the computer program is stored.

### STATE OF THE ART

From DE 10 2017 211 209, a method for the automatic setting of at least one parameter of an actuator regulation system is known, which is designed to regulate a regulation variable of an actuator to a pre-definable target variable, wherein the actuator regulation system is designed, depending on the at least one parameter, the target variable and the regulation variable to generate a correcting variable and to control the actuator as a function of this correcting variable,

wherein a new value of the at least one parameter is selected as a function of a long-term cost function, wherein this long-term cost function is determined as a function of a predicted time evolution of a probability distribution of the regulation variable of the actuator and the parameter is then set to this new value.

### ADVANTAGE OF THE INVENTION

In contrast, a method for operating an actuator regulation system which is set up for regulating a regulation variable of an actuator to a pre-definable target variable, the actuator regulation system being set up to generate a correcting variable as a function of a variable characterizing a regulation strategy and to control the actuator as a function of this correcting variable, wherein the variable characterizing the regulation strategy is determined as a function of a value function, has in particular the advantage that an optimal regulation of an actuator regulation system can be guaranteed. Advantageous further developments are the subject matter of the dependent claims.

### DISCLOSURE OF THE INVENTION

In a first aspect, the invention relates to a method for operating an actuator regulation system which is set up for regulating a regulation variable of an actuator to a pre-definable target variable, wherein the actuator regulation system is set up to generate a correcting variable as a function of a variable characterizing a regulation strategy, in particular also as a function of the target variable and/or the regulation variable, and to drive the actuator as a function of this correcting variable,

wherein the variable characterizing the regulation strategy is determined as a function of a value function.

By determining the value function, it is possible to guarantee optimum regulation of the actuator regulation system, even in cases in which the state variables and/or actions are not limited to discrete values but can attain continuous values.

In particular, the regulation strategy can be determined in such a manner that for each regulation variable, the action from which the correcting variable is derived is determined, which maximizes the value function.

In a further development, it is provided that the value function is determined iteratively by gradually approximating the value function by means of the Bellman equation by subsequent iterations of an iterated value function, wherein an iterated value function of a subsequent iteration is determined from an iterated value function of a previous iteration by means of the Bellman equation, wherein only its projection onto a linear functions space, spanned by a set of basic functions, is used to solve the Bellman equation instead of the iterated value function of the previous iteration.

In particular, this ensures that the iteratively determined value function maximizes a pre-defined reward, especially in the long term and taking into account the system dynamics. By using the projections, it is possible to solve the Bellman equation, which can only be solved analytically point by point because of a maximum value formation contained in it, particularly easily by approximation.

It is especially advantageous, if instead of the iterated value function of the subsequent iteration only its projection onto a functions space spanned by a second set of basic functions is determined.

Thus, it is possible to determine this projection without having to completely calculate the iterated value function of the subsequent iteration itself.

Integrals of the Bellman equation, which are particularly easy to solve analytically, are obtained when Gaussian functions are used as basic functions. This makes the method numerically particularly efficient.

Because of the maximum value formation of the Bellman equation, it can generally only be evaluated at individual points. A complete solution is nevertheless possible if the integral in the Bellman equation is calculated using numerical quadrature. Therefore, the use of numerical quadrature is numerically particularly efficient.

In a further aspect of the invention it is provided, if a subsequent set of basic functions is determined iteratively by adding at least one further basic function to the set depending on it, how large a maximum residuum is between the iterated value function and its projection onto the functions space spanned by this set.

By this iterative procedure, a numerical error of the method can be limited particularly efficiently to a pre-definable maximum value and thus the actuator regulation system can be operated particularly reliably.

In a further development it can be provided that at least one further basic function is selected depending on a maximum point of the regulation variable at which the residuum becomes maximum.

This makes the method particularly efficient, since a numerical error can be reduced particularly quickly by the projection onto the functions space spanned by the set of basic functions.

The efficiency is particularly high if the at least one additional basic function at the maximum point takes on its maximum value.

Alternatively or additionally, it further increases the efficiency of the method if the at least one further basic function is selected depending on a quantity characterizing a curvature of the residuum at the maximum point, in particular the Hesse matrix of the residuum at the maximum point.

It is particularly easy, especially in the case of multi-dimensional regulation variables, if at least one further basic function is selected in such a manner that its Hesse matrix at the maximum point is equal to the Hesse matrix of the residuum.

In a further aspect of the invention it can be provided that a conditional probability on which the Bellman equation depends is determined by means of a model of the actuator. This also makes the method particularly efficient, as it is not necessary to determine the actual behavior of the actuator again.

Here it is particularly advantageous if the model is a Gaussian process. This is particularly advantageous if the basic functions are given by Gaussian functions, since the occurring integrals can then be solved analytically as integrals via products of Gaussian functions, which enables a particularly efficient implementation.

In order to obtain a particularly good regulating behavior of the actuator regulation system, it may be provided according to a further aspect of the invention that the teaching of the actuator regulation system and the teaching of the model is determined in an episodic procedure, which means that after the determination of the variable characterizing the regulation strategy, the model is made dependent on the correcting variable, which is fed to the actuator in the case of a regulation of the actuator with the actuator regulation system, taking into account the regulation strategy, and is adapted to the resulting regulation variable, wherein after adaptation of the model, the variable characterizing the regulation strategy is determined again with the method described above, wherein the conditional probability is then determined by means of the now adapted model.

In a further aspect, the invention relates to a learning system for automatically setting a variable characterizing a regulation strategy of an actuator regulation system, which is arranged to regulate a regulation variable of an actuator to a pre-definable target variable, the learning system being arranged to carry out one of the aforementioned methods.

In a further aspect, the invention relates to a method in which the variable characterizing the regulation strategy is determined according to one of the aforementioned methods and then, depending on the variable characterizing the regulation strategy, the manipulated variable is generated and the actuator is controlled depending on this correcting variable.

In a further aspect, the invention relates to an actuator regulation system which is set up to control an actuator using this method.

In a yet another aspect, the invention relates to a computer program which is set up to perform one of the aforementioned methods. In other words, the computer program comprises instructions which, when executed on a computer, cause that computer to perform the method.

The invention further relates to a machine-readable storage medium on which this computer program is stored.

### BRIEF DESCRIPTION OF THE DRAWINGS

Subsequently, embodiments of the invention are explained in more detail with reference to the enclosed drawings. In which:

FIG. 1 is a schematic representation of an interaction between the learning system and actuator;

FIG. 2 is a schematic representation of an interaction between the actuator regulation system and actuator;

FIG. 3 is an embodiment of the method for training the actuator regulation system in a flowchart;

FIG. 4 is an embodiment of a method for determining iterated value functions in a flowchart;

FIG. 5 is an embodiment of a method for determining a set of basic functions in a flowchart;

FIGS. 6A and 6B show an embodiment of methods for determining the correcting variable in a flowchart.

### DESCRIPTION OF THE EMBODIMENTS

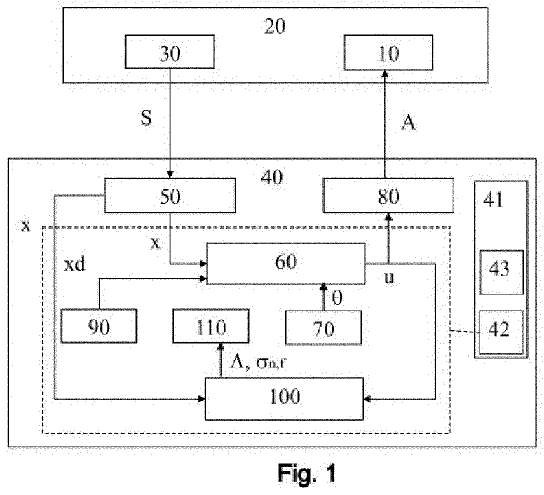

FIG. 1 shows the actuator 10 in its environment 20 in interaction with the learning system 40. The actuator 10 and the environment 20 are collectively referred to below as the actuator system. A state of the actuator system is detected by a sensor 30, which may also be provided by a plurality of sensors. An output signal S of the sensor 30 is transmitted to the learning system 40. The learning system 40 determines therefrom a drive signal A, which the actuator 10 receives.

The actuator 10 can be, for example, a (partially) autonomous robot, for example a (partially) autonomous motor vehicle, a (partially) autonomous lawnmower. It may also be an actuation of an actuator of a motor vehicle, for example, a throttle valve or a bypass actuator for idle control. It may also be a heating installation or a part of the heating installation, such as a valve actuator. The actuator 10 may in particular also be larger systems, such as an internal combustion engine or a (possibly hybridized) drive train of a motor vehicle or even a brake system.

The sensor 30 may be, for example, one or a plurality of video sensors and/or one or a plurality of radar sensors and/or one or a plurality of ultrasonic sensors and/or one or a plurality of position sensors (for example GPS). Other sensors are conceivable, for example, a temperature sensor.

In another embodiment example, the actuator 10 may be a manufacturing robot, and the sensor 30 may then be, for example, an optical sensor that detects characteristics of manufacturing products of the manufacturing robot.

The learning system 40 receives the output signal S of the sensor 30 in an optional receiving unit 50, which converts the output signal S into a regulation variable x (alternatively, the output signal S can also be taken over directly as the regulation variable x). The regulation variable x may be, for example, a section or a further processing of the output signal S. The regulation variable x is supplied to a regulator 60. In the regulator either a regulation strategy it can be implemented, or a value function V*.

In a parameter memory 70, parameters θ are deposited, which are supplied to the regulator 60. The parameters θ parameterize the regulation strategy π or the value function V*. The parameters θ can be a singular or a plurality of parameters.

A block 90 supplies the regulator 60 with the pre-definable target variable xd. It can be provided that the block 90 generates the pre-definable target variable xd, for example, as a function of a sensor signal that is predefined for the block 90. It is also possible for the block 90 to read the target variable xd from a dedicated memory area in which it resides.

Depending on the regulation strategy π or the value function V*, on the target variable xd and the regulation variable x, the regulator 60 generates a correcting variable u. This can be determined, for example, depending on a difference x-xd between the regulation variable x and target variable xd.

The regulator 60 transmits the correcting variable u to an output unit 80, which determines the drive signal A therefrom. For example, it is possible that the output unit first checks whether the correcting variable u is within a pre-definable variable range. If this is the case, the control signal A is determined as a function of the correcting variable u, for example by an associated drive signal A being read from a characteristic field as a function of the correcting variable u. This is the normal case. If, on the other hand, it is determined that the correcting variable u is not within the pre-definable value range, it can be provided that the control signal A is designed in such a manner that it causes the actuator A to enter a safe mode.

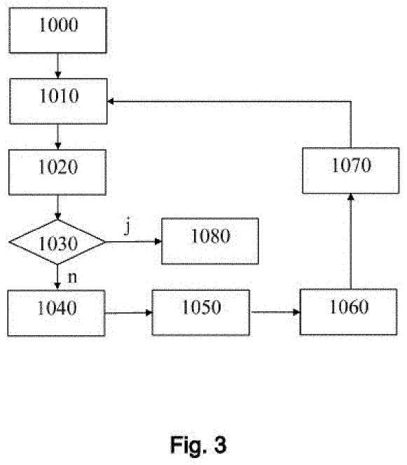

Receiving unit 50 transmits the regulation variable x to a block 100. Similarly, the regulator 60 transmits the corresponding correcting variable u to the block 100. Block 100 stores the time series of the regulation variable x received at a sequence of times and the respective corresponding correcting variable u. Block 100 can then adapt model parameters Λ, σₙ, σ_{f} of the model g on the basis of these time series. The model parameters Λ, σₙ, σ_{f} are supplied to a block 110, which stores them, for example, at a dedicated storage position. This will be described in more detail below in FIG. 3, step 1010.

The learning system 40, in one embodiment, comprises a computer 41 having a machine-readable storage medium 42 on which a computer program is stored that, when executed by the computer 41, causes it to perform the described functionality of the learning system 40. In the embodiment, the computer 41 comprises a GPU 43.

The model g can be used for the determination of the value function V*. This is explained below.

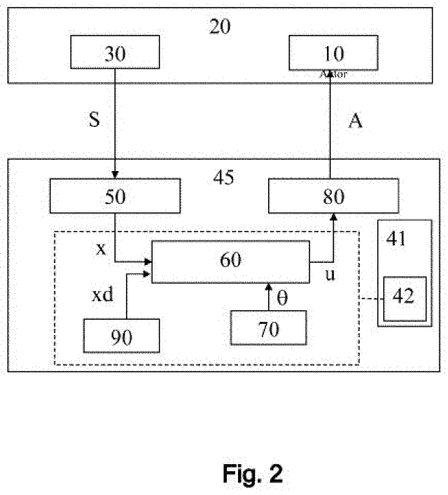

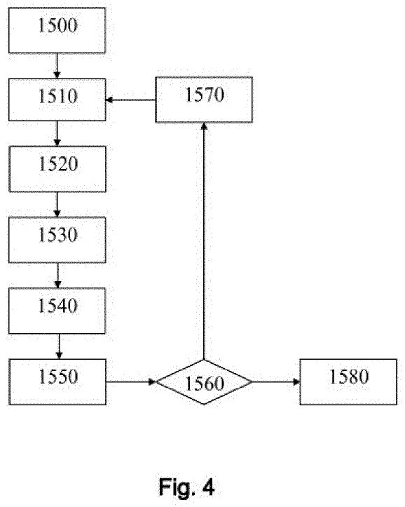

FIG. 2 illustrates the interaction of the actuator regulation system 45 with the actuator 10. The structure of the actuator regulation system 45 and its interaction with the actuator 10 and sensor 30 is similar in many parts to the structure of the learning system 40, which is why only the differences are described here. In contrast to the learning system 40, the actuator regulation system 45 has no block 100 and no block 110. The transmission of variables to the block 100 is therefore eliminated. In the parameter memory 70 of the actuator regulation system 45, parameters θ are deposited, which were determined by the method according to the invention, for example, as illustrated in FIG. 4.

FIG. 3 illustrates an embodiment of the method according to the invention. First (1000), an initial value x₀ of the regulation variable x is selected from a pre-definable initial probability distribution p(x₀). An episode index e is initialized to the value e=1, a value function \hat{V}ₑ assigned to this episode index e is initialized to the value \hat{V}^{e}=0.

In addition, correcting variables u₀, u₁, . . . , u_{T-1} are randomly selected up to a pre-definable time horizon T with which the actuator 10 is controlled as described in FIG. 1. The actuator 10 interacts via the environment 20 with the sensor 30, whose sensor signal S is received as a regulation variable x₁, . . . , x_{T-1}, x_{T} indirectly or directly from the regulator 60.

These are combined into a data set [symbol] ={(x₀, u₀, x₁), . . . , (x_{T-1}, u_{T-1}, x_{T}}.

Block 100 receives and aggregates (1030) the time series of correcting variable u and regulation variable x which together result in a pair z of regulation variable x and correcting variable u, zₜ=(xₜ¹, . . . , xₜ^{D}, uₜ¹ . . . uₜ^{F})^{T}.

D is thereby the dimensionality of the regulation variable x and F is the dimensionality of the correcting variable u, i.e. x ∈ [symbol] ^{D}, u ∈ [symbol] ^{F}.

Depending on this state trajectory, then a Gaussian process g is adapted in such a manner that between successive times t, t+1 the following applies

xₜ₊₁=xₜ+g(xₜ, uₜ). (1)

Here

uₜ=π_{θ}(xₜ). (1′)

A covariance function k of the Gaussian process g is, for example, given by

k(z, w)=σ_{f}² exp(−1/2 (z−w)^{T}Λ⁻¹(z−w). (2)

Parameter σ_{f}² is a signal variance, Λ=diag(l₁² . . . l_{D+F}²) is a collection of squared length scales l₁² . . . l_{D+F}² for each of the D+F input dimensions.

A covariance matrix K is defined by

K(Z, Z)_{i,j}=k(zⁱ, z^{j}). (3)

The Gaussian process g is then characterized by two functions: By an average μ and a variance Var, which are given by

μ(z*)=k(z*, Z)(K(Z, Z)+σₙ²l)⁻¹y, (4)

Var(z*)=k(z*, z*)−k(z*, Z)(K(Z, Z)+σₙ²l)⁻¹k(Z, z*). (5)

Here y is given in the usual way by yⁱ=f(zⁱ)+∈ⁱ, with white noise ∈ⁱ.

The parameters Λ, σₙ, σ_{f} are then matched to the pairs (zⁱ, yⁱ) in a known manner by maximizing a logarithmic marginal likelihood function.

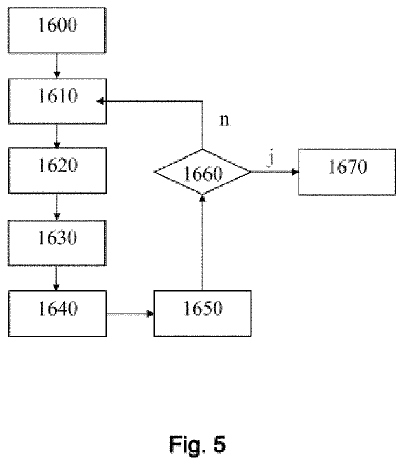

Then (1020) iterated value functions \hat{V}ₑ¹, \hat{V}ₑ², . . . \hat{V}*ₑ associated with the episode index e are determined, the last of these iterated value functions being a converged iterated value function \hat{V}*ₑ associated with the episode index e. An embodiment of the method for determining the iterated value functions \hat{V}ₑ¹, \hat{V}ₑ², . . . \hat{V}*ₑ assigned to the episode index e is illustrated in FIG. 5.

Then (1030) it is checked to see if the converged iterated value function \hat{V}*ₑ associated with the episode index e is converged, for example by checking whether the converged iterated value functions assigned to the current episode index e and the iterated value functions \hat{V}*ₑ, \hat{V}*ₑ₋₁ assigned to the previous episode index e−1 differ by less than a first pre-definable limit of a function Δ₁, i.e. ∥\hat{V}*ₑ−\hat{V}*ₑ₋₁∥<Δ₁. If this is the case, step 1080 follows.

However, if convergence has not yet been achieved (1040), an optimal regulation strategy πₑ associated with the episode index e is defined by

πₑ(x)=argmaxᵤ∫p(x′|x, u)\hat{V}*ₑ(x′)dx′. (6)

Then (1050) the initial value x₀ of the regulation variable x is again selected from the initial probability distribution p(x₀).

Using the optimum regulation strategy πₑ defined in formula (6), a sequence of regulation variables πₑ(x₀), . . . ,πₑ(x_{T-1}) is now (1060) iteratively determined with which the actuator 10 is controlled. From the then received output signals S of the sensor 30, the resulting state variables x₁, . . . , x_{T} are then determined.

Now (1070) the episode index e is incremented by one, and it branches back to step 1030.

If it was decided in step 1030 that the iteration over episodes has led to a convergence of the iterated value functions \hat{V}*ₑ assigned to the episode index e, the value function V* is set equal to that of the iterated value functions \hat{V}*ₑ assigned to the episode index e. This ends this aspect of the method.

FIG. 4 illustrates an embodiment of the method for determining the iterated value functions \hat{V}ₑ¹,\hat{V}ₑ², . . . , \hat{V}*ₑ assigned to the episode index e. For reasons of clarity, the episode index e is omitted below. The superscript index is hereinafter referred to by the letter t. The method always calculates a subsequent iterated value function \hat{V}^{t+1}, always based on the previous value function \hat{V}^{t}. This previous iterated value function \hat{V}^{t} is given as a linear combination \hat{V}^{t}=Σᵢ₌₁^{N}^{ₜ} αᵢ^{t}·ϕᵢ^{t} with basic functions {ϕᵢ^{t}}_{i≤N}_{ₜ} and coefficients {αᵢ^{t}}_{i≤N}_{ₜ}. These coefficients {αᵢ^{t}}_{i≤N}_{ₜ} are also briefly summarized in a coefficient vector α^{t}. The method starts (1500) with the index t=0.

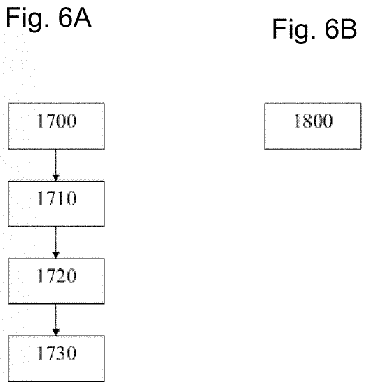

First, a set B of basic functions {ϕᵢ^{t+1}}_{i≤N}_{ₜ₊₁} is determined (1510). These can either be predefined, or they can be determined using the algorithm illustrated in FIG. 6.

Then (1520) scalar products Mᵢⱼ= [symbol] ϕᵢ^{t+1}|ϕⱼ^{t+1} [symbol] _{L}_{²} for i, j=1 . . . Nₜ₊₁ are determined.

Subsequently (1530), nodes ξ₁, . . . , ξ_{K} and associated weights w₁, . . . , w_{K} are defined using numerical quadrature.

With the help of these nodes ξ₁, . . . , ξ_{K} and weights w₁, . . . , w_{K} then (1540) for all indices i=1 . . . Nₜ₊₁ coefficients bᵢ^{t+1} of a vector b^{t+1} are determined to

bᵢ^{t+1}=Σₖ₌₁^{K}wₖϕᵢ^{t+1}(ξₖ)A\hat{V}^{t}(ξₖ). (7)

A coefficient vector α^{t+1} is now (1550) determined to α^{t+1}=M⁻¹b^{t+1}, wherein a mass matrix M is given by M=(Mᵢⱼ)_{i,j≤N}_{ₜ₊₁}.

The operator A is defined as

$$A {\hat{V}}^{t} ( x ) = {max}_{u} \int ( p ( {x}^{′} \vert x , u ) \cdot ( r ( {x}^{′} ) + γ {\hat{V}}^{t} ( {x}^{′} ) ) ) {dx}^{′} . \qquad ( 8 )$$

Here, 0<γ<1 is a specifiable weighting factor, e.g.: γ=0.85. r is a reward function that assigns a reward value to a value of the regulation variable x. Advantageously, reward function r is selected in such a manner that the smaller a deviation of the regulation variable x from the target variable xd is, the larger the value it assumes.

The conditional probability p(x′|x,u) of the regulation variable x′ given the previous regulation variable x and the manipulated variable u can be determined in formula (8) using the Gaussian process g.

It should be noted that the max operator in formula (8) is not accessible to an analytical solution. However, for a given regulation variable x, the maximization can take place in each case by means of a gradient ascent method.

These definitions ensure that the subsequent iterated value function \hat{V}^{t+1}=Σᵢ₌₁^{N}^{ₜ₊}1·99 ᵢ^{t+1} defined in this way corresponds to a projection of an actual iterated value function V^{t+1} onto the space spanned by the basic functions B, wherein the actual iterated value functions satisfy the Bellman equation

$${V}^{t + 1} ( s ) = {max}_{u} \int ( p ( {x}^{′} \vert x , u ) \cdot ( r ( {x}^{′} ) + γ {V}^{t} ( {x}^{′} ) ) ) {dx}^{′} . \qquad ( 9 )$$

The vector b^{t+1} thus approximately satisfies the equation bᵢ^{t+1}= [symbol] ϕᵢ^{t+1}|V^{t+1} [symbol] _{L}_{²}, wherein it was recognized that this equation, which can be solved exactly only in exceptional cases, can be solved, if both the actual value function V^{t+1} is replaced by its projection onto the space spanned by the basic functions B, i.e. by the iterated value function \hat{V}^{t+1}, and the resulting integral equation with numerical quadrature is solved approximately.

Now (1560) it is checked whether a termination criteria is satisfied. The termination criteria can be satisfied, for example, if the iterated value function \hat{V}^{t+1} is converged, for example, if a difference to the previous iterated value function \hat{V}^{t} becomes smaller than a second limit of a function Δ₂, i.e. ∥\hat{V}^{t+1}−\hat{V}^{t}∥<Δ₂. The termination criteria can also be considered as satisfied if the index t has reached the pre-definable time horizon T.

If the termination criteria is not satisfied, the index t is increased by one (1570). If, on the other hand, the termination criteria is satisfied, the value function V* is set equal to the iterated value function \hat{V}^{t+1} of the last iteration.

This ends this part of the method.

FIG. 5 illustrates an embodiment of the method for determining the set B of basic functions for the actual iterated value function V^{t} of the Bellman equation. For this purpose, first (1600) the set B of basic functions is initialized as an empty set, an index I is initialized to the value I=0. An iterated value function \hat{V}^{t,l} projected onto the set B of basic functions is also initialized to the value 0.

Then (1610) a residuum R^{t,l}(x)=|\hat{V}^{t}(x)−\hat{V}^{t,l}(x)| is defined as the deviation between the iterated value function \hat{V}^{t} and the corresponding projected iterated value function \hat{V}^{t,l}.

Then (1620) a maximum point x*=arg maxₛ R^{t,l}(x) of the residuum is determined, e.g. with a gradient ascent method, and a Hesse matrix H^{t,l} of the residuum R^{t,l} is determined at the maximum digit x*.

Now (1630) a new basic function ϕₗ₊₁^{t} to be added to the set B of basic functions is determined. The new basic function ϕₗ₊₁^{t} to be added is preferably chosen as a Gaussian function with mean value s* and a covariance matrix Σ*. The covariance matrix Σ* is calculated in such a manner that it fulfills the equation

Σ*⁻¹=−R^{t,l}(x*)⁽⁻²⁾∇^{T}R^{t,l}(x)|_{x=x.} ∇R^{t,l}(x)|ₓ₌ₓ. +R(x*)⁻¹H^{t,l}. (10)

Then (1640) this basic function ϕₗ₊₁^{t} is added to the set B of basic functions.

Now (1650) the projected iterated value function \hat{V}^{t,l+1} is determined by the projection of the iterated value function \hat{V}^{t} onto the function space spanned by the now extended set B of basic functions.

Subsequently (1660) it is checked whether the determination of the projected iterated value function \hat{V}^{t,l+1} is sufficiently converged, for example by checking whether an associated norm (e.g. a L_{∞} norm) of the deviation falls below a third pre-definable limit of a function Δ₃, i.e. ∥\hat{V}^{t,l+1}−\hat{V}^{t}∥L_{∞}<Δ₃.

If this is not the case, the index I is incremented by one and the method branches back to step 1610.

Otherwise, the determined set B={ϕᵢ^{t}}_{i≤l+1} is returned as a searched set of basic functions and this part of the method ends.

FIG. 6 illustrates the embodiments of the method for determining the correcting variable and FIG. 6A illustrates an embodiment for the case that the parameters θ deposited in the parameter storage 70 parameterize the regulation strategy π. For this purpose, first (1700) a set of test points xᵢ is defined, for example as a Sobol design plan.

Then (1710) optimum correcting variables xᵢ assigned to the test points uᵢ are calculated using the formula

uᵢ=argmax_{u∈U}∫p(x′|xᵢ, u)V*(x′)dx′ (11)

e.g. are determined with a gradient ascent method, and a training set M={(x₁, u₁), (x₂, u₂), . . . } is created from pairs of the test points xᵢ with the respective assigned optimum manipulated variables uᵢ.

With this training set M a data-based model is then (1720) taught, for example a Gaussian process g_{θ}, so that the data-based model efficiently determines an assigned optimum correcting variable u for a regulation variable x. The parameters g_{θ}characterizing the Gaussian process θ are deposited in the parameter storage 70.

The steps (1700) to (1720) are preferably executed in the learning system 40.

During operation of the actuator regulation system 45 (1730), this system then determines the associated correcting variable u for a given regulation variable x using the Gaussian process g_{θ}.

This ends this method.

FIG. 6B illustrates an embodiment for the case that the parameters θ deposited in the parameter storage 70 parameterize the value function V*. For this purpose, in step (1800) for a given regulation variable x, analogous to step (1710), the associated correcting variable u defined by equation

u=argmaxᵤ∫p(x′|x, u)V*(x′)dx′

is determined with a gradient ascent method.

This ends this method.

1.-18. (canceled)

19. A method for operating an actuator regulation system to regulate an actuator, comprising:
regulating a regulation variable of an actuator to a pre-definable target variable,
generating a correcting variable as a function of a variable characterizing a regulation strategy, wherein the variable characterizing the regulation strategy is determined as a function of a value function, and
controlling the actuator as a function of the correcting variable,
wherein the value function is determined by gradually approximating the value function using a Bellman equation by successive iterations of an iterated value function,
wherein an iterated value function of a subsequent iteration is determined by the Bellman equation from an iterated value function of a previous iteration,
wherein for a solution of the Bellman equation, instead of the iterated value function of the previous iteration, only a projection of the Bellman equation onto a functions space spanned by a set of basic functions is used.

20. (canceled)

21. The method according to claim 19, wherein also instead of the iterated value function of the subsequent iteration only a projection of the Bellman equation onto a functions space spanned by a second set of basic functions is determined.

22. The method according to claim 19, wherein Gaussian functions are used as basic functions.

23. The method according to claim 19, wherein a value of an integral of the Bellman equation is determined by numerical quadrature.

24. The method according to claim 19, wherein a subsequent set of basic functions is determined iteratively by adding at least one further basic function to the set depending on how large a maximum residuum is between the iterated value function and its projection onto the function space spanned by said set.

25. The method according to claim 24, wherein the at least one further basic function is selected depending on a maximum point of the regulation variable at which the residuum becomes maximum.

26. The method according to claim 25, wherein the at least one additional basic function assumes its maximum value at a maximum point.

27. The method according to claim 25, wherein the at least one additional basic function is selected depending on a variable characterizing a curvature of the residuum at the maximum point, using a Hesse matrix of the residuum at the maximum point.

28. The method according to claim 27, wherein the at least one additional basic function is selected in such a manner that at the maximum point its Hesse matrix is equal to the Hesse matrix of the residuum.

29. The method according to claim 19, wherein a conditional probability on which the Bellman equation depends is determined using a model of the actuator.

30. The method according to claim 29, wherein the model is a Gaussian process.

31. The method according to claim 29, wherein, after the determination of the variable) characterizing the regulation strategy, the model is adapted as a function of the correcting variable, which is fed to the actuator during a regulation of the actuator with the actuator regulation system taking into account the regulation strategy, and the then resulting regulation variable, wherein after the adaptation of the model the variable characterizing the regulation strategy is determined again, wherein the conditional probability is then determined by the now adapted model.

32. The method according to claim 19, wherein the correcting variable is generated as a function of the variable characterizing the regulation strategy and the actuator is controlled as a function of this correcting variable.

33.-37. (canceled)
